(19) United States
(12) Patent Application Publication
(10) Pub. No.: US 2002/0051537 A1
(43) Pub. Date: May 2, 2002

(54) Method and apparatus for realizing a parallelizable variable-input-length pseudorandom function

(76) Inventor: Phillip W. Rogaway, Davis, CA (US)

Correspondence Address: PARK, VAUGHAN & FLEMING LLP, 508 SECOND STREET, SUITE 201, DAVIS, CA, 95616, US

(21) Appl. No.: 09/948,084

(22) Filed: Sep. 5, 2001

Related U.S. Application Data
(60) Provisional application No. 60/232,326, filed on Sep. 13, 2000.
(60) Provisional application No. 60/240,471, filed on Oct. 12, 2000.

(51) Int. Cl. H04L 9/00

(52) U.S. Cl. 380/46

(57) ABSTRACT

A parallelizable variable-input-length pseudorandom function constructed out of a fixed-input-length pseudorandom function. The variable-input-length pseudorandom function can be used as a message authentication code. The fixed-input-length pseudorandom function from which it is built can be a block cipher. In one embodiment, using an n-bit block cipher, the given key is mapped into a sequence of offsets, and the given message is partitioned into n-bit message blocks and a final fragment that may be shorter. Each message block is xored with a corresponding offset and then the block cipher is applied. The resulting output blocks are xored together, and also xored with the padded final fragment, to yield a partial checksum. An additional offset may then be xored into the partial checksum, depending on the length of the final fragment, to yield a checksum. The block cipher is then applied to the checksum, the result being the output of the function constructed.

### RELATED APPLICATION

This application hereby claims priority under 35 U.S.C. section 119 to U.S. Provisional Patent Application No. 60/232,326, filed Sep. 13, 2000, and Provisional Application Serial No. 60/240,471, filed Oct. 12, 2000. The above-referenced Provisional Patent applications are hereby incorporated by reference.

### BACKGROUND

1. Field of the Invention

The present invention relates generally to cryptographic techniques for the construction of message authentication codes, and, more particularly, to a way to use a block cipher in order to construct a parallelizable variable-input-length pseudorandom function that combines desirable efficiency and security characteristics.

2. Related Art

When two parties, a Sender and a Receiver, communicate, the Receiver may need to verify that a message purportedly coming from a particular Sender really does come from that Sender. To this end, the Sender and Receiver may possess a shared secret key that they use to authenticate the Sender's transmissions. The most common approach is for the Sender to attach to each message a short string (e.g., 64 bits) that serves to authenticate the message to which it is attached. This string is called an authentication tag. The authentication tag is computed using a message authentication code, which entails a MAC-generation procedure and a MAC-verification procedure. The Sender applies the MAC-generation procedure to compute the authentication tag from the key, the message, and sometimes, additionally, a nonce. (A nonce is a value used at most once with the associated key—for example, a counter or random string.) The Receiver, on receipt of a message and its associated authentication tag, applies the MAC-verification procedure to the key, the received message, and the received authentication tag, to determine if the message should be regarded as authentic or inauthentic. To “MAC” a message means to computes its authentication tag using a message authentication code.

Various means to compute a MAC are known in the art, as described, for example, in the book of Menezes, van Oorschot and Vanstone, Handbook of Applied Cryptography, published by CRC Press, 1997. A common approach is to base the message authentication code on a block cipher.

By way of background, a block cipher is a mechanism E that takes a key K and an input block X, the input block being a binary string of some fixed length n. The block cipher produces from this an output block Y=E_{K}(X), which is also a binary string of length n. The number n is called the block length of the block cipher. To be called a block cipher, it is required that for each key K, the function E_{K} be a one-to-one and onto function from the set of n-bit strings to the set of n-bit strings. Well-known block ciphers include the algorithm of the Data Encryption Standard (DES), which has a block length of n=64 bits, and the algorithm of the Advanced Encryption Standard (AES), which has a block length of n=128 bits. A block cipher with block length n is called an n-bit block cipher. We shall speak of enciphering to refer to the process of taking an input block X and computing from it the output block E_{K}(X) for some understood key K and block cipher E. The result of enciphering an input block X is called a ciphertext block.

More generally, an n-bit to n′-bit pseudorandom function (an n-bit to n′-bit PRF) is a function E that takes a key K and a string X having n bits and produces from this a string Y=E_{K}(X) having n′ bits, where n and n′ are constants. Strings X and Y are the input block and the output block, respectively. Numbers n and n′ are the input length and the output length, respectively. A block cipher is one kind of n-bit to n′-bit pseudorandom function, where n=n′ and E_{K} is a permutation. Applying a PRF refers to the process of taking an input block X and computing from it an output block E_{K}(X) for some understood key K and pseudorandom function E. We shall sometimes call this process enciphering X, and refer to Y as a ciphertext, even if E is not necessarily a block cipher. When there is no need to specify the value n′, we refer to an n-bit to n′-bit PRF as an n-bit PRF. When there is no need to specify n or n′, we refer to an n-bit to n′-bit PRF as a fixed-input-length PRF (an FIL PRF).

A variable-input-length pseudorandom function (VIL PRF) is a function E that takes as input a key K and a message M, the message M being a string of arbitrary length, and where E produces from this a string E_{K}(X) having some fixed length t. The number t is the output length of the PRF. A variable-input-length PRF can always be used as a message authentication code, as is well known to those skilled in the inventive art. When using a VIL PRF as a MAC, the MAC-generation method consists of applying the VIL PRP to the message M, using the shared MAC key as the PRF key. This yields the authentication tag, Tag. MAC-verification mechanism takes the received message and applies to it the VIL PRF, using the shared MAC key as the PRF key. This yields an anticipated tag, Tag′. If the anticipated tag Tag′ is identical to the authentication tag Tag which was received along with the message, then the message is regarded as authentic; otherwise, the message is regarded as inauthentic. With an eye towards its most customary usage, we refer to the output of a VIL PRF as an authentication tag.

A block cipher E, a fixed-input-length pseudorandom function E, and a variable-input-length pseudorandom function E, are all meant to possess the following property: if the key K is random and unknown, then a black-box for E_{K}(·) should be adversarially indistinguishable from a random function with the same domain and range as E.

The customary approach for making a message authentication code from an n-bit block cipher E is the cipher block chaining message authentication code (CBC MAC). In the CBC MAC, the message M to be authenticated must be a binary string of length that is a positive multiple of n. The message M is partitioned into n-bit blocks M[1], M[2], . . . , M[m] by taking M[1] as the first n bits of M, taking M[2] as the next n bits of M, and so forth. One then computes the authentication tag for M, using key K, by the following MAC-generation algorithm:

function CBC-MAC_{K}(M)

C[0]=0

for i=1 to m do

C[i]=Eₖ(M[i]⊕C[i−1])

return C[m]

In the algorithm above and henceforth, 0 (an emboldened 0) means a string of n zero-bits. The CBC MAC is shown in FIG. 4. For each input block M[i], the algorithm enciphers the result of xoring M[i] and the previous output block C[i-1]. The result of the final enciphering is the authentication tag.

MAC-verification works by re-computing the anticipated authentication tag for the supplied message and verifying that it is identical to the supplied authentication tag. Indeed this is the way that MAC verification always works when the MAC is nonceless—a nonceless MAC being one in which the MAC-generation procedure is a deterministic procedure of just the key and the message.

The CBC MAC works with any n-bit pseudorandom function, though it is usually used with a block cipher.

There are many extensions of the CBC MAC which are known in the art: various standards allow one to pad M, to encipher C[m], or to truncate the final result. But all variants of the CBC MAC share the way of “chaining” that has been described, and they all, therefore, share the following characteristic: that the i^{th} ciphertext block, C[i], can not be computed until the (i-1)^{st} ciphertext block, C[i-1], has already been computed. This makes the CBC MAC inherently sequential. This characteristic limits the speed of the CBC MAC. In particular, special-purpose hardware is limited in speed by the latency of the underlying block cipher E, while execution on modern CPUs (which allow multiple instructions to be dispatched in a single cycle) are limited by the amount of parallelism that can be extracted from E. The CBC MAC is said to be serial.

The XOR MAC

To get around the serial nature of the CBC MAC, other ways to use a pseudorandom function to make a MAC are known in the art. In U.S. Pat. No. 5,673,318 and U.S. Pat. No. 5,757,913, the inventors describe the following technique, which is called the XOR MAC. The MAC-generation technique is illustrated in FIG. 5. Let E be an n-bit to n′-bit PRF (most commonly, a block cipher would be used). Let k be a number less than n. The message M is partitioned into k-bit message blocks, M[1], M[2], . . . , M[m]. (One assumes that M is of a length divisible by k, and one further assumes that m<2^{n-k}.) Each message block M[i] is encoded along with the block index i in order to produce an n-bit input block <i, M[i]>. The function E_{K} is applied to each n-bit input block to create a plurality of output blocks, each having n′ bits. A nonce, Nonce, is encoded into an n-bit header as <0, Nonce>. The PRF E_{K} is applied to the header to yield an n′-bit enciphered header. The m output blocks and the one enciphered header are xored together to create the tag, Tag. The tag together with the nonce provides the authentication tag (Nonce, Tag).

For the XOR MAC, the MAC-verification technique makes use of the MAC-generation technique. The Receiver who knows K and obtains a message M with its authentication tag (Nonce, Tag) can use the MAC-generation algorithm described above to compute the anticipated tag, Tag′, that “should” accompany message M when using nonce Nonce. If Tag=Tag′ then the Receiver regards M as valid. Otherwise, the Receiver rejects the message M, regarding it as invalid.

Note that the content of each input block is independent of the content of other input blocks, so each message block can be processed independently of the others, allowing parallelization. The XOR MAC is said to be parallelizable.

Limitations of the XOR MAC

There are at least three limitations of the XOR MAC.

The first limitation of the XOR MAC arises from the use of the nonce, which is usually a counter or random value. This counter or random value must be communicated to the Receiver in the authentication tag, increasing the length of the authentication tag compared to a nonceless scheme. In addition, the Sender needs either a source of random bits or else the Sender needs to maintain state (for the counter). These options may be unavailable or inconvenient for the Sender.

A second limitation of the XOR MAC is the wastage of bits in forming the input words. Since each n-bit input block is obtained by encoding a k-bit message block M[i] and the index i, the number k must be less than n in order to leave adequate room for the index i. When the PRF that is employed is an n-bit block cipher, the number of block-cipher calls will exceed the number of n-bit blocks in the message. This makes the technique less serial-efficient than the CBC MAC. To make the XOR MAC as serial-efficient as possible, one is motivated to make k almost as large as n. But k can not be too close to n, because the index i for each block must be encoded in n-k bits, so n-k determines the maximum length of any message that can be handled. As an illustrative example, when using a 64-bit block cipher, one may wish to allocate 32 bits for the message block and 32 bits for the index. (In this manner one can handle messages of up to 2³²-1 32-bit blocks.) In such a case, the XOR MAC has a serial efficiency which is approximately half that of the CBC MAC.

A third limitation of the XOR MAC is that it only works on messages whose length is a positive multiple of k, the length of the message blocks. To handle strings whose length is not a positive multiple of k, additional techniques are required.

Methods to Overcome the Limitations of the XOR MAC

There exist methods to separately overcome the above-described limitations of XOR MAC.

A method to overcome the first limitation of the XOR MAC (its requiring state or randomness) is described in the article of D. Bernstein entitled How to stretch random functions: the security of protected counter sums, appearing in the Journal of Cryptology, vol. 12, no. 3, pages 197-215, 1999. Bernstein's variant of the XOR MAC is shown in FIG. 6. Bernstein's construction assumes an n-bit to k-bit pseudorandom function, F, where n>k (as a typical example, take n=640 and k=512). Bernstein assumes that messages to be authenticated have fewer than 2^{n-k} k-bit blocks. The message M is partitioned into k-bit message blocks M[1], M[2], . . . , M[m]. Each k-bit message block M[i] is appended to an (n-k)-bit encoding of the number i, thereby forming an n-bit input block <i, M[i]>. An n-bit to k-bit pseudorandom function, keyed by the MAC key K, is applied to each of input blocks to obtain corresponding k-bit output blocks. The output blocks are xored together to form an k-bit checksum, Σ. The checksum is appended to n-k 0-bits to form the n-bit string <0, Σ>. The n-bit to k-bit pseudorandom function is applied to <0, Σ> to yield the k-bit authentication tag, Tag.

Bernstein's approach addresses the first limitation: no nonce or random value is used. The method does not address the other two limitations. What is more, a block cipher cannot be used with this technique, since one requires a pseudorandom function with an input length n exceeding its output length k.

The second limitation of the XOR MAC (it's “wastage” of bits for block indices) is overcome in a manuscript of V. Gligor and P. Donescu entitled Fast encryption and authentication: XCBC encryption and XECB authentication modes, dated Aug. 18, 2000 and first appearing on the first author's web site. The authors provide a method, the XECB MAC, which authenticates a message using an n-bit block cipher and does not use any bits for block indices.

The XECB MAC is shown in FIG. 7. The method assumes an n-bit block cipher (or an n-bit PRF), E. The message M to authenticate is partitioned into n-bit message blocks M[1], . . . , M[m]. A nonce Nonce, which the authors call a counter, is used, and an enciphered nonce R=E_{K}(Nonce) is determined by enciphering it. A sequence of offsets is constructed, z[1], z[2], . . . , where z[1]=R and, for i≧1, z[i]=(z[i-1]+R) mod 2ⁿ. Equivalently, z[i]=iR mod 2ⁿ. For each number i between 1 and m, one constructs an input block X[i]=(M[i]+z[i]) mod 2ⁿ. Each input block is enciphered to give a corresponding output block, Y[i]. All of the output blocks are xored together, and the result is further xored with the enciphered nonce R. The result is the value denoted Tag. It is encoded along with the nonce Nonce to yield the authentication tag (Nonce, Tag).

The Receiver who obtains a message M and its authentication tag (Nonce, Tag) can check the authenticity of M by the natural algorithm: compute the “anticipated” tag Tag′ for M using nonce Nonce and see if it matches the value Tag actually received within the authentication tag.

The [Gligor, Donescu] technique continues to have the first and third limitation we have described: the scheme uses a nonce and assumes that messages are of length divisible by n. One further limitation of the technique concerns its use of mod 2ⁿ addition, which is used both to form offsets and to combine them with message blocks. The use of mod 2ⁿ addition can be inconvenient, for a number of reasons. The value n will typically be 128 (the block size for modern block ciphers). In hardware, adding two 128-bit quantities requires significant chip area. In software, the operation tends to be slower than xor, and the machine instruction that one would like to use to implement a 128-bit addition is usually not accessible when programming in a high-level programming languages. Addition is inherently “endian biased”, so a scheme that uses n-bit addition will necessarily favor big-endian architectures or little-endian architectures; it will not be possible to construct an endian-neutral scheme.

A couple of different approaches for constructing sequences of offsets were developed for a different context, authenticated encryption, by C. Jutla. They are described in Jutla's manuscript Encryption modes with almost free message integrity, which first appeared on Aug. 1, 2000, as item 2000/039 on the IACR's Cryptology ePrint server. One approach involves the use mod-p addition, where p is a prime just less than 2ⁿ. A second approach involves repeatedly using the block cipher, keyed by a new key, to construct “basis vectors” IV[1], IV[2], . . . . These basis vectors are xored in various combinations as a way of constructing offsets.

The third limitation of the XOR MAC (that messages are assumed to have a length which is a positive multiple of n) can be overcome by standard padding techniques. The usual approach is to append to the message M a “1” bit and then the minimum number of “0” bits so that the padded message will have a length this is a multiple of n. The disadvantage of this approach is that it results in an extra application of the function E every time the message is of a length that is a positive multiple of n. There are more sophisticated padding techniques known, particularly the technique taught by J. Black and P. Rogaway in the paper entitled CBC MACs for arbitrary-length messages: The three-key constructions, which appears in Advances in Cryptology—CRYPTO 2000, Lecture Notes in Computer Science, vol. 1880, pages 197-215, Springer-Verlag, 2000. This paper teaches, among other techniques, the use of two different keys that are xored into the last block of a message before the CBC MAC is applied to it. This technique is specific to the CBC MAC.

Having thus described the some of the related art, one sees that there remains a need for a block-cipher mode of operation that allow the construction of a parallelizable message authentication code that simultaneously overcomes the limitations described.

### SUMMARY

Variations on the present invention provide methods for constructing efficient variable-input-length pseudorandom functions. The constructed VIL PRFs can be used in the customary manner for making message authentication codes. The inventive methods give rise to VIL PRFs (and message authentication codes) that combine any or all of the following properties: (1) They are nonceless (no counter or random value is made use of), like all PRFs. (2) They are fully parallelizable. (3) They operate on messages of arbitrary bit length. (4) They avoid the possibility of an extra block-cipher call, as would be caused by the use of obligatory padding. (5) They require little session-setup time. (6) Needed offsets are constructed in a particularly efficient manner. (7) Extended-precision arithmetic (e.g., mod 2ⁿ addition) is avoided.

To achieve these and other goals, new techniques have been developed. A first set of techniques concern the structure of the VIL PRF that is being constructed. A second set of techniques concern improved ways to generate the needed offsets. A third set of techniques deal with methods to avoid the use of multiple block-cipher keys. The different types of improvements are largely orthogonal.

One embodiment of the inventive method begins by partitioning the message into a sequence of n-bit message blocks, together with a message fragment, which has n or fewer bits. The key K is used to determine a sequence of n-bit offsets, z[−1],z[1],z[2], . . . . Each message block M[i] is combined with a corresponding offset z[i] to produce a corresponding input block, and these input blocks are each enciphered to get a collection of output blocks. The message fragment is padded, if necessary, and the padded message fragment is combined with all of the output blocks to produce a checksum, Σ. The checksum is enciphered to yield the authentication tag.

Offsets can be produced using the techniques already known in the art and described previously, but we also describe a new approach for making offsets. In it, the key K is mapped to a key variant L, and L determines basis offsets L(−1), L(1), L(2), . . . . These basis offsets are produced from L using simple shifts and conditional xor operations; the block cipher is not employed. Different subsets of L(i)-values are now xored together, in an advantageous order, to construct the different offsets.

### BRIEF DESCRIPTION OF THE FIGURES

FIG. 1 describes “PMAC”, where PMAC is the name for one embodiment of many of the techniques taught in the present invention.

FIG. 2 gives a high-level description of PMAC's process for making offsets, in accordance with an embodiment of the present invention.

FIG. 3 gives a low-level description of PMAC's process for making offsets, in accordance with an embodiment of the present invention.

FIG. 4 depicts the CBC MAC.

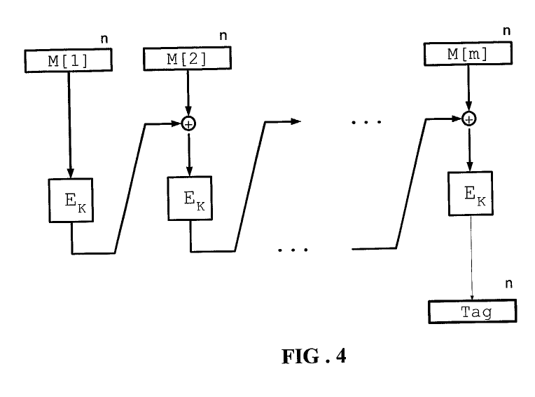

FIG. 5 depicts the XOR MAC of Bellare, Guerin, and Rogaway.

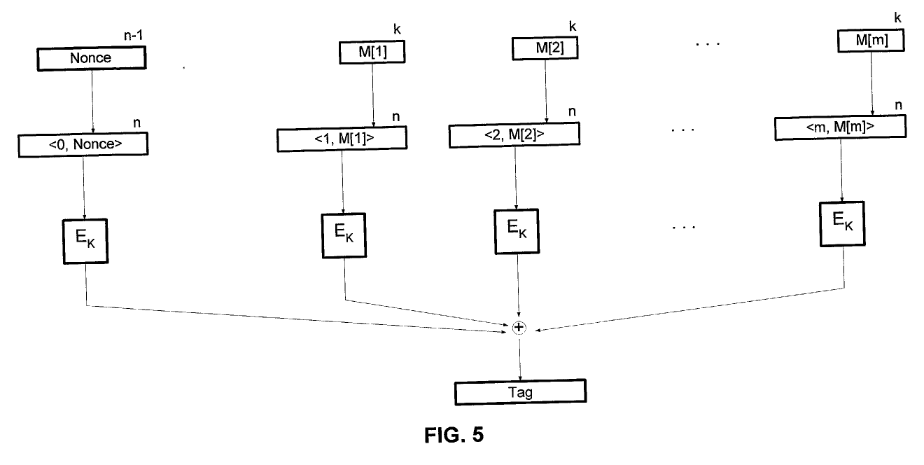

FIG. 6 depicts the variant of the XOR MAC due to Bernstein.

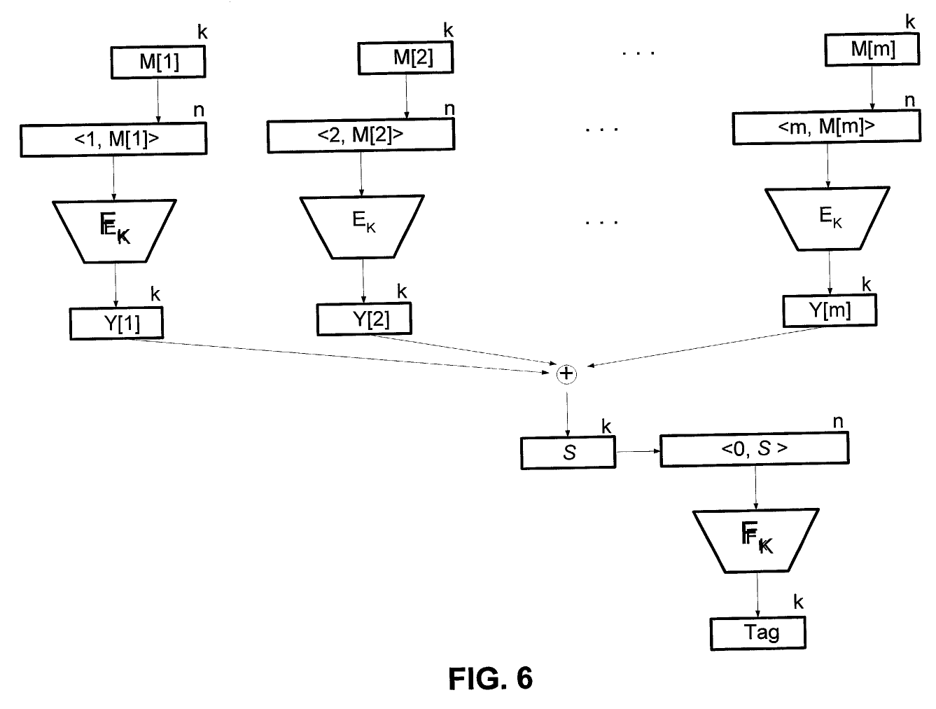

FIG. 7 depicts the XECB MAC of Gligor and Donescu.

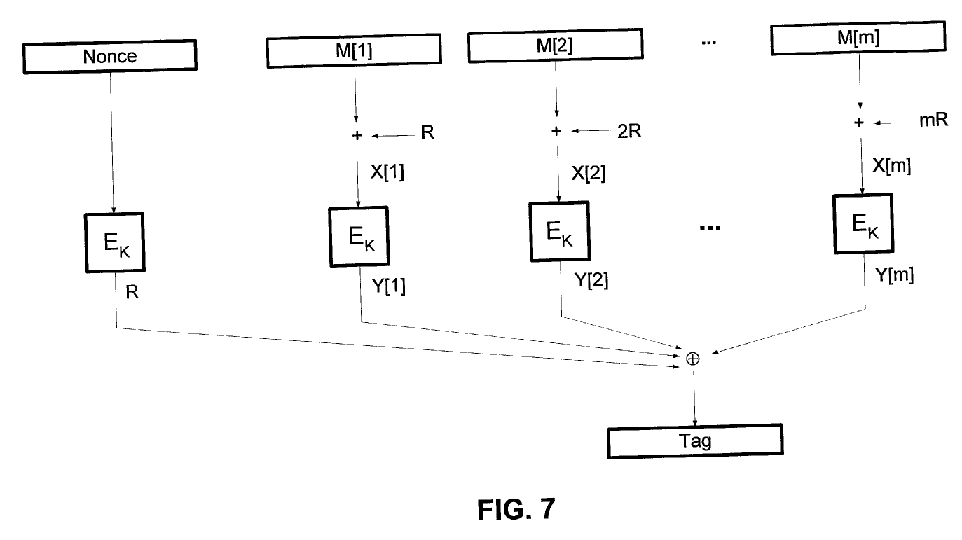

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

We now describe an embodiment of the present invention known as PMAC (for \ddot{p}arallelizable \ddot{m}essage äuthentication \ddot{c}ode.) PMAC is a variable-input-length PRF that uses an n-bit PRF E (typically a block cipher) to determine a t-bit tag Tag from a message M and a key K for the block cipher E. Like any VIL PRF, one can use PMAC as a message authentication code. To specify PMAC we begin by giving some notation and reviewing some mathematical background.

Notation and Mathematical Background

If a and b are integers, a≦b, then [a . . . b] is the set of all integers between and including a and b. If i≧1 is an integer then ntz(i) is the number of trailing 0-bits in the binary representation of i (equivalently, ntz(i) is the largest integer z such that 2^{z} divides i). So, for example, ntz(7)=0 and ntz(8)=3.

A string is a finite sequence of symbols, each symbol being 0 or 1. The string of length 0 is called the empty string and is denoted ε. Let {0,1}* denote the set of all strings. If A, B ε {0,1}* then A B, or A∥B, is their is their concatenation. If A ∈ {0,1}* and A≠ε then firstbit(A) is the first bit of A and lastbit(A) is the last bit of A. Let i and n be nonnegative integers. Then 0ⁱ and 1ⁱ denote strings of i 0's and 1's, respectively. For n understood, 0 means 0ⁿ. Let {0,1}ⁿ denote the set of all strings of length n. If A ∈ {0,1}* then |A| is the length of A, in bits, while |A|ₙ =max(1, ┌|A|/n┐ is the length of A in n-bit blocks, where the empty string counts as one block. For A ∈ {0,1}* and |A|≦n, padₙ(A) is A if |A|=n and padₙ(A) is the string A ∥10^{n-|A|-1} if |A|<n. With n understood we write pad(A) instead of padₙ(A). If A ∈ {0,1}* and t ∈ [0 . . . |A|] then A[first t bits] and A[last t bits] are the first t bits of A and the last t bits of A, respectively. Both of these values are the empty string if t=0. If A, B ∈ {0,1}* then A⊕B is the bitwise xor of A[first s bits] and B[first s bits] where s=min{|A|,|B|}; for example 1001⊕110=010.

If A=aₙ₋₁ . . . a₁ a₀ ∈ {0,1}ⁿ is a string, each aᵢ ∈ {0,1}, then str2num(A) is the number Σ_{0≦i≦n-1} 2ⁱ aᵢ that this string represents, in binary. If a ∈ [0 . . . 2ⁿ⁻¹] is a number, then num2strₙ(a) is the n-bit string A such that str2num(A)=a. Let lenₙ(A) num2strₙ(|A|) be the string that encodes the length of A as an n-bit string. We omit the subscript n when it is understood.

If A=aₙ₋₁ nₙ₋₂ . . . a₁ a₀ ∈ {0,1}ⁿ then A<<1=aₙ₋₂ . . . a₁ a₀ 0 is the n-bit string which is a left shift of A by 1 bit (the first bit of A disappearing and a zero coming into the last bit), while A>>1=0 aₙ₋₁ aₙ₋₂ . . . a₁ is the n-bit string which is a right shift of A by one bit (the last bit disappearing and a zero coming into the first bit).

In pseudocode we write “Partition M into M[1] . . . M[m]” as shorthand for “Let m=|M|ₙ and let M[1], . . . , M[m] be strings such that M[1] . . . M[m]=M and |M[i]|=n for 1≦i<m.” Recall that |M|ₙ=max {1, ┌|M|n┐}, so the empty string partitions into m=1 blocks, that one block being the empty string.

By way of mathematical background, recall that a finite field is a finite set together with an addition operation and a multiplication operation, each defined to take a pair of points in the field to another point in the field. The operations obey certain basic axioms defined by the art. (For example, there is a point 0 in the field such that a+0=0+a=a for every a; there is a point 1 in the field such that a•1=1•a=a for every a; and for every a≠0 there is a point a⁻¹ in the field such that a•a⁻¹=a⁻¹•a=1). For each number n there is a unique finite field (up to the naming of the points) that has 2ⁿ elements. It is called the Galois field of size 2ⁿ, and it is denoted GF(2ⁿ).

We interchangeably think of a point a ∈ GF(2ⁿ) in any of the following ways: (1) as an abstract point in a field; (2) as an n-bit string aₙ₋₁ . . . a₁ a₀ ∈ {0,1}ⁿ; (3) as a formal polynomial a(x)=aₙ₋₁ x^{x-1}+ . . . +a₁ x+a₀ with binary coefficients; (4) as a nonnegative integer between 0 and 2ⁿ⁻¹, where the string a ∈ {0,1}ⁿ corresponds to the number str2num(a). For example, one can regard the string a =0¹²⁵101 as a 128-bit string, as the number 5, as the polynomial x²+1, or as a particular point in the finite field GF(2¹²⁸), We write a(x) instead of a if we wish to emphasize the view of a as a polynomial in the formal variable x.

To add two points in GF(2ⁿ), take their bitwise xor. We denote this operation by a⊕b.

Before we can say how to multiply two points we fix some irreducible polynomial polyₙ(x) having binary coefficients and degree n. For PMAC, choose the lexicographically first polynomial among the irreducible degree-n polynomials having a minimum number of coefficients. For n=128, the indicated polynomial is poly₁₂₈(x)=x¹²⁸+x⁷+x²+x+1.

To multiply points a, b ∈ GF(2ⁿ), which we denote a•b, regard a and b as polynomials a(x) and b(x), form their product polynomial c(x) (where one adds and multiplies coefficients in GF(2)), and take the remainder one gets when dividing c(x) by the polynomial polyₙ(x).

By convention, the multiplication operator has higher precedence than addition operator and so, for example, γ₁•L⊕R means (γ₁•L)⊕R.

It is particularly easy to multiply a point a ∈ {0,1}ⁿ by x. We illustrate the method for n=128, where polyₙ(x)=x¹²⁸+x⁷+x²+x+1. Multiplying a=aₙ₋₁ . . . a₁ a₀ by x yields the polynomial aₙ₋₁ xⁿ+aₙ₋₂ xⁿ⁻¹+a₁ x²+a₀ x. Thus, if the first bit of a is 0, then a•x=a<<1. If the first bit of a is 1 then we add x¹²⁸ to a<<1. Since x¹²⁸+x⁷+x²+x+1=0 we know that x¹²⁸=x⁷=x²+x+1, so adding x¹²⁸ means to xor by 0¹²⁰10000111. In summary, when n=128,

a<<1 if firstbit(a)=0, and

a•x=(a<<1)⊕0¹²⁰10000111 if firstbit(a)=1

If a ∈ {0,1}ⁿ then we can divide a by x, meaning that one multiplies a by the multiplicative inverse of x in the field: a•x⁻¹. It is easy to compute a•x⁻¹. To illustrate, again assume that n=128. Then if the last bit of a is 0, then a•x⁻¹ is a>>1. If the last bit of a is 1, then we add (xor) to a>>1 the value x⁻¹. As x¹²⁸=x⁷+x²+x+1 we have x¹²⁷=x⁶+x+1+x⁻¹ and so x⁻¹=x¹²⁷+x⁶+x+1=10¹²⁰1000011. In summary, for n=128,

a>>1 if lastbit(a)=0, and

a•x⁻¹=(a>>1)⊕10¹²⁰1000011 if lastbit(a)=1

If L ∈ {0,1}ⁿ and n≧−1, we write L(i) for L•xⁱ. There is an easy way to compute L(−1),L(0),L(1), . . . , L(u), for a small number u. Namely, set L(0)=L; compute L(i)=L(i-1)•x from L(i-1), for all i ∈ [1 . . . u], using a shift and a conditional xor (with the formula we have given); and compute L(−1) from L by a shift and a condititional xor (with the formula we have given).

Still by way of background, a Gray code is an ordering of the points of {0,1}^{s} (for some number s) such that successive points differ (in the Hamming sense) by just one bit. For n a fixed number, like n=128, OCB uses the canonical Gray code Gray(n)=(γ₀, γ₁, . . . γ_{2ˆ n-1}). Gray(n) is defined as follows: Gray(1)=(0,1) and Gray(s) is constructed from Gray(s-1) by first listing the strings of Gray(s-1) in order, each preceded by a 0-bit, and then listing the strings of Gray(s-1) in reverse order, each preceded by a 1 bit. It is easy to see that Gray(n) is a Gray code. What is more, γᵢ can be obtained from γᵢ₋₁ by xoring γᵢ₋₁ with the string 0ⁿ⁻¹ 1<<ntz(i). This makes successive strings easy to compute.

By way of example, Gray(128)=(0,1,3,2,6,7,5,4, . . . ). To see this, start with (0, 1). Then write it once forward and once backwards, (0,1,1,0). Then write (00,01,11,10). Then write this once forward and once backwards, (00,01,11,10,10,11,01,00). Then write(000,001,011,010,110,111,101,100). At this point we already know the first 8 strings of Gray(128), which are (0,1,3,2,6,7,5,4), where these numbers are understood to represent 128-bit strings. So, for example, γ₅ is 7 and γ₆ is 5, and γ₆=5 is indeed γ₅=7 xored with 2, where 2 is the string 1 shifted left ntz(6)=1 positions.

Let L ∈ {0,1}ⁿ and consider the problem of successively forming the strings γ₁•L, γ₂•L, γ₃•L, . . . , γₘ•L. Of course γ₁•L=1•L=L. Now, for i≧2, assume one has already computed γᵢ₋₁•L. Since γ₁=γᵢ₁γ(0ⁿ⁻¹ 1<<ntz(i)) we know that

$$\begin{matrix}{γ}_{1} \cdot L = ( {γ}_{i - 1} ⊕ ( {0}^{n - 1} 1 \&LeftSkeleton; ntz ( i ) ) \cdot L \\ = {γ}_{i - 1} \cdot L ⊕ ( {0}^{n - 1} 1 \&LeftSkeleton; ntz ( i ) ) \cdot L \\ = {γ}_{i - 1} \cdot L ⊕ ( L \cdot {x}^{ntz ( i )} ) \\ = {γ}_{i - 1} \cdot L ⊕ L ( ntz ( i ) )\end{matrix}$$

That is, the i-th string in the sequence is obtained by xoring the previous string in the sequence with L(ntz(i)).

Definition of PMAC

With the necessary notation and background now in place, we are ready to describe PMAC. The mechanism depends on two parameters: an n-bit PRF, E, and a tag length, t, where t is a number between 1 and n. With these two parameters fixed, PMAC maps a string of arbitrary length into a string of length t.

A popular block cipher to use with OCB is likely to be the AES algorithm (AES128, AES192, or AES256). As for the tag length, a suggested default of t=64 is reasonable, but tags of any length are fine.

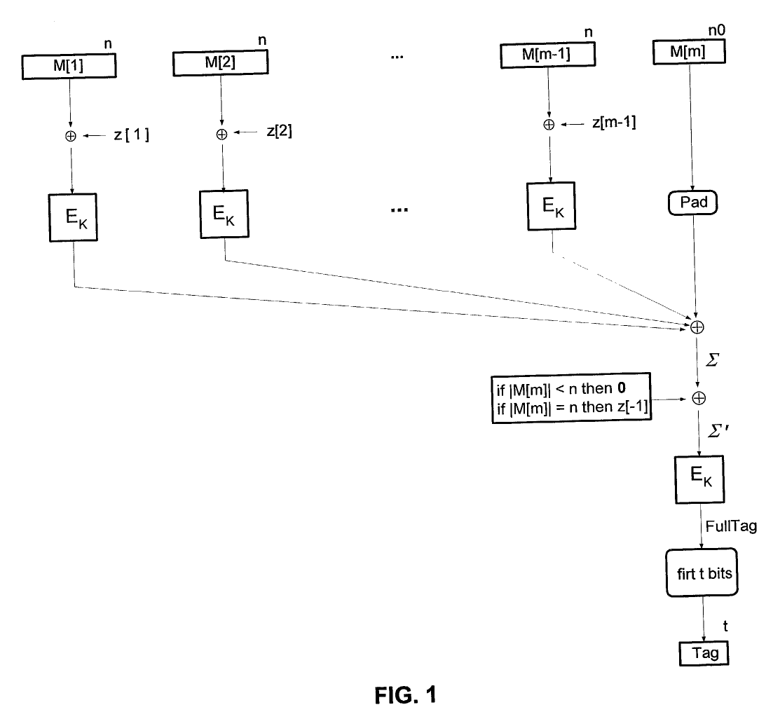

See FIG. 1 for an illustration of PMAC. The figure is best understood in conjunction with the algorithm definition of Table 1, which explains all of the figure's various parts and gives additional algorithmic details. The key space for PMAC is the key space for the underlying block cipher E.

TABLE 1

Algorithm PMAC _{K} (M)
L = E_{K}(0)
for i = 1 to m

do z[i] = γᵢ • L

z[−i] = L • x⁻¹
Partition M into M[1] . . . M[m]
for i = 1 to m−1 do

Y[i] = E_{K}(M[i] ⊕ z[i])

Σ = Y[1] ⊕ Y[2] ⊕ . . . ⊕ Y[m−1]
if|M[m]|<n then Σ′ = Σ

else Σ′ = Σ⊕ z[−1]

FullTag = E_{K}(Σ′)
Tag = FullTag [first t bits]

return Tag

Referring to FIG. 1 and Table 1, one sees that the message M has been partitioned into n-bit blocks M[1], . . . M[m-1], as well as a message fragment, M[m], which may have fewer than n bits. The message blocks and the final fragment are treated differently. Each message block is xored with an offset (the corresponding z[i] value) and then enciphered. The message fragment is 10 . . . 0-padded if it has fewer than n bits, and left alone if it has n bits. The enciphered message blocks and the padded message fragment are all xored together. To this is also xored the offset z[−1] in the case that the final fragment was n bits long. The result is enciphered, and the authentication tag is a prefix of that enciphered string.

Offsets are constructed as follows. For i≧1, offset z[i] is defined γᵢ•L; that is, L times the i-th number in the Gray-code sequence Gray(n), the multiplication in GF(2ⁿ). Offset z[−1] is defined as L•x⁻¹. We have already explained how to efficiently calculate these values.

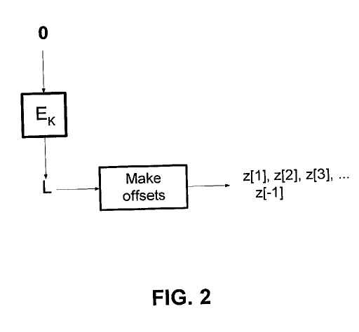

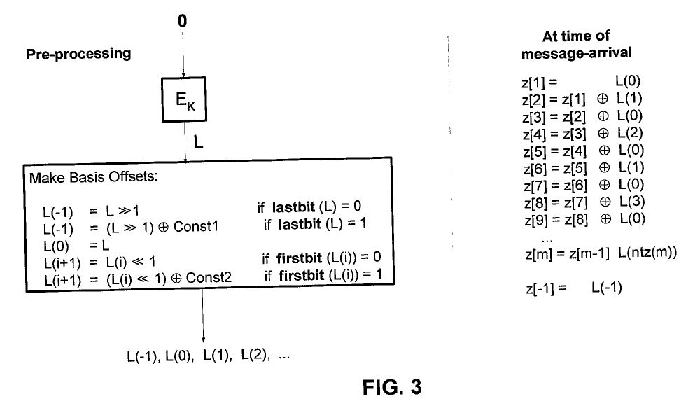

FIGS. 2 and 3 clarify the make-offset process that is used in PMAC but which is only partially depicted in FIG. 1. First, FIG. 2 gives a high-level view of how the underlying key K is mapped into a key variant L and then the sequence of offsets z[1], z[2], z[3], . . . , as well as the value z[−1]. Note that once the key variant L has been constructed, the block cipher and the key K are no longer needed for offset construction. Next, FIG. 3 shows the inventive offset-generation process in more detail. The sequence of fixed offsets that we choose is z[1]=γ₁•L, z[2]=γ₂•L, z[3]=γ₃•L, and so on. These offsets can be calculated as follows. In a pre-processing step we map L, which is key variant determined by enciphering the constant string 0, into a sequence of basis offsets L(−1), L(0), L(1), L(2), . . . . Basis offset L(i) is defined to be L•xⁱ. We have already explained how to easily compute these strings. Now we compute offsets as follows. The first offset, z[1], is defined as L(0). Offset z[2] is computed from offset z[1] by xoring z[1] with L(1). One chooses L(1) because we are making offset number 2 and the number 2, written in binary, ends with 1 zero-bit. Offset z[3] is computed from offset z[2] by xoring z[2] with L(0). One chooses L(0) because we are making offset 3 and 3, written in binary, ends with 0 zero-bits. Offset z[4] is computed from offset z[3] by xoring into z[3] with L(2). One chooses L(2) because we are making offset 4 and 4, written in binary, ends with 2 zero-bits. And one continues in this way, constructing each offset from the prior offset by xoring in the appropriate L(i) value.

As with any VIL PRF, the usual way to use PMAC to authenticate messages is to have the Sender, when he wants to transmit M, compute Tag=PMAC_{K} (M) and send it along with M. The Receiver, on receipt of (M, Tag), computes Tag′=PMAC_{K} (M). The Receiver may accept the received transmission if Tag=Tag′, but the Receiver will reject the received transmission if Tag≠Tag′. There may be further checks performed by the Receiver—for example, using techniques well-known in the art to detect replay attacks.

An Alternative Description

At this point, we have described an embodiment of PMAC. Still, the following alternative description may help to clarify what a typical implementation might choose to do when using the inventive VIL PRF as a message authentication code.

Key generation: Choose a random key K from the key space for the n-bit PRF E. The key K is provided to both the Sender (who sends authenticated messages) and the Receiver (who verifies them).

Session setup: With the key now distributed, the following can be done: Setup the block-cipher key. Both the Sender and the Receiver do any key setup that is useful for applying the PRF (if the PRF is a block cipher, it will be applied only in its forward direction). Pre-compute L. Let L=E_{K}(0). Pre-compute L(i)-values. Let mₘₐₓ be at least as large as the number of n-bit blocks in any message to be MACed. Let u=┌log₂(mₘₐₓ−1)┐. Let L(0)=L and, for i ∈ 1 . . . u], compute L(i) =L(i-1)•x using a shift and a conditional xor, in the manner already described. Compute L(−1)=L•x⁻¹ using a shift and a conditional xor, in the manner already described. Save L(−1), L(0), . . . , L(u) in a table.

MAC generation: To generate the authentication tag for a message M ∈ {0,1}*, the Sender will do the following: Partition M. Let m=┌|M|/n┐. If m=0 then replace m by 1. Let M[1], . . . , M[m] be strings such that M[1] . . . M[m]=M and |M[i]51 =n for all i ∈ [1 . . . m-1]. Initialize variables. Let Offset=0. Let Σ=0. Encipher all blocks but the last one. For i=1 to m-1, do the following: let Offset =Offset⊕L(ntz(i)); let Y[i]=E_{K}(M[i]⊕Offset); let Σ=Σ⊕Y[i]. Compute the authentication tag: Let Σ=Σ⊕pad(M[m]). If |M[m]|<n the let PreFullTag=Σ else let PreFullTag=Σ⊕z[−1]. Let FullTag=E_{K}(PreFullTag). Let Tag be the first t bits of FullTag. Attach the authentication tag Tag to the message that is being transmitted.

MAC verification. To test if (M, Tag′) is authentic, the Receiver will do the following: Re-MAC the message. Generate the authentication tag Tag′ for the message M that was just received using the MAC-generation procedure just described. Compare the presented authentication tag and the computed authentication tag. If Tag=Tag′ then regard message M as authentic. If Tag ≠Tag′ then regard the message M as inauthentic.

Variations

Many variants of PMAC are possible. One type of variant leaves the structure of PMAC alone, but changes the way offsets are produced (and possibly the semantics of the xor operations that are used to combine offsets with other strings). We give a couple of examples.

For a mod 2ⁿ version of PMAC, let z[i]=iL mod 2ⁿ. That is, z[0]=0 and, for i≧1, z[i]=(z[i-1]+L) mod 2ⁿ, and, finally, z[−1] is the opposite of L, as a binary number. Now replace xor, where it was used to combine an offset z[i]and a message block M[i], and where it was used to combine z[−1] and a partial sum, by mod 2ⁿ addition.

For a mod p version of PMAC, let p=2ⁿ−δ be a prime, for some small number δ. For example, let p be the largest prime less than 2ⁿ. Let z[i]=iL mod p, for all i≧1.

Slightly more efficient than the mod p method described above, change the semantics of addition to be that one drops the carry bit but increments the sum by δ whenever a carry is generated. Multiplication by a positive number i means repeated addition. Now offset z[1]=L and offset z[i]=(z[i-1]+L) mod 2ⁿ if this addition does not generate a carry, and z[i]=(z[i-1]+L+δ) mod 2ⁿ if it does. We refer to this method as lazy modp addition.

For the mod p and lazy mod p variants, xor can still be used, instead of mod p addition or lazy mod p addition, for purposes of combining an offset z[i] and a message block M[i], and for combining offset z[−1] and the partial sum.

For some embodiments of the invention it may be desirable to place additional restrictions on L. For example, in the first variant of PMAC that was described, there are certain efficiency advantages that can be gained by forcing the top few bits of L to 0, or by forcing the top few bits of each 32-bit word of L to 0. Thus one may wish to AND a 128-bit value L with a constant like 0²1³⁰0²1³⁰0²1³⁰0²1³⁰ before using it. Similarly, for the mod 2ⁿ scheme, there appear to be some advantages to forcing the low bit of L to be 1 (that is, forcing L to be an odd number), which can be done by ORing L with the constant 0¹²⁷1 (for n=128).

For the mod 2ⁿ scheme and the mod p scheme, bitwise complement can be used instead of a negative. These operations are almost identical, as −A differs from the complement of A by a constant, 1, which is irrelevant. Similarly, for the GF(2ⁿ) scheme, it is fine to define z[−1] by L>>1, or by L(n-1). Again, these values are “effectively” the same, since L(−1) is either L>>1 or something that differs from this by a constant, and similarly for L(n-1), which differs from L(−1) (in the xor-sense) by one of two possible constants.

Many other correct variants of PMAC are possible, as a person skilled in the art will now be able to discern.

Though the PRF used in PMAC will most often be a block cipher, we emphasize that we have never used the permutivity of this function, nor that its input length is equal to its output length. Thus, for example, the compression function of a cryptographic hash function (e.g., the compression function of SHA1) would make an acceptable fixed-input-length PRF, E, for the purposes of PMAC.

We likewise emphasize that, while we have often spoken of message authentication codes as our goal, what is constructed by the inventive methods has the stronger property of being a VIL PRF. While any VIL PRF can be used for message authentication, in the manner we have described, a VIL PRF has uses beyond message authentication. For example, a VIL PRF can be used to perform key separation, and can be used to generate pseudorandom sequences of number, those numbers used for cryptographic purposes (like key generation) or non-cryptographic purposes (like scientific simulation).

The particular message content is not a limitation of the present invention. Thus, the message should be understood to be any string, irrespective of the particular application for which the message is used. The string may be plaintext or ciphertext (that is, privacy protection may or may not have been already provided).

For any VIL PRF producing n′-bit outputs, it is always the case that one can select a portion of the output to use as a shorter-output-length VIL PRF. This fact is obvious and well known to those skilled in the inventive art. It is therefore unnecessary to explicitly reflect the bit-selection step (extracting some t bits of the full tag) in the claims.

Execution Vehicles

The computation of the inventive VIL PRF may reside, without restriction, in software, firmware, or in hardware. The execution vehicle might be a computer CPU, such as those manufactured by Intel Corporation and used within personal computers. Alternatively, the process may be performed within dedicated hardware, as would typically be found in a cell phone or a wireless LAN communications card or the hardware associated to the Access Point in a wireless LAN. The process might be embedded in the special-purpose hardware of a high-performance encryption engine. The process may be performed by a PDA (personal digital assistant), such as a Palm Pilot®. In general, any engine capable of performing a complex sequence of instructions and needing to provide a privacy and authenticity service is an appropriate execution vehicle for the invention.

The various processing routines that comprise the present invention may reside on the same host machine or on different host machines interconnected over a network (e.g., the Internet, an intranet, a wide area network (WAN), or local area network (LAN)). Thus, for example, the MAC generation for a message may be performed on one machine, with the associated MAC verification is performed on another machine, the two communicating over a wired or wireless LAN. In such a case, a machine running the present invention would have appropriate networking hardware to establish a connection to another machine in a conventional manner. Though we speak of a Sender and a Receiver performing MAC generation and verification, respectively, in some settings (such as file encryption) the Sender and Receiver may represent a single entity, at different points in time.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for computing a variable-input-length pseudorandom function using an n-bit pseudorandom function, which transforms a key and a message to an authentication tag, the method comprising:
generating a sequence of offsets from the key;
partitioning the message into a sequence of n-bit message blocks and a message fragment having at most n bits;
combining each message block with a corresponding offset to get a corresponding input block;
applying the n-bit pseudorandom function to each input block to get a corresponding output block;
computing a checksum as a function of at least the output blocks and the final fragment; and
computing the authentication tag by applying the n-bit pseudorandom function to the checksum.

2. The method of claim 1, wherein generating the sequence of offsets involves:
determining the 1^{st} offset as a function of the key; and
determining the i^{th} offset, for each i>1, a function of the first offset and the number i.

3. The method of claim 1, wherein generating the sequence of offsets involves:
determining a plurality of basis offsets;
determining each offset in the sequence of offsets by combining a given set of basis offsets.

4. The method of claim 3, wherein the order that basis offsets are combined to make the i^{th} offset is determined by a Gray code.

5. The method of claim 1, wherein generating the sequence of offsets involves:
determining a stride and a first offset from the key; and
determining each subsequent offset by combining the prior offset and the stride.

6. A method for computing a variable-input-length pseudorandom function that transforms a key and a message to an authentication tag, the method comprising:
generating a sequence of offsets from the key;
partitioning the message into a message core and a message fragment;
computing a partial checksum as a function of the message core, the sequence of offsets, and the key;
computing a final checksum as a function of at least the partial checksum and the message fragment; and
computing the authentication tag as a function of the final checksum and the key.

7. A method for authenticating messages, using a key, that associates to each message an authentication tag, comprising:
generating a sequence of offsets from the key;
partitioning the message into a message core and a message fragment;
computing a partial checksum as a function of the message core, the sequence of offsets, and the key;
computing a final checksum as a function of at least the partial checksum and the message fragment;
computing the authentication tag as a function of the final checksum and the key.

8. A method for verifying the authenticity of messages, using a key, wherein a message is presented along with a purported authentication tag, comprising:
generating a sequence of offsets from the key;
partitioning the message into a message core and a message fragment;
computing a partial checksum as a function of the message core, the sequence of offsets, and the key;
computing a final checksum as a function of at least the partial checksum and the message fragment;
computing an authentication tag as a function of the final checksum and the key;
regarding the message as authentic if the authentication tag equals the purported authentication tag; and
regarding the message as inauthentic if the authentication tag differs from the purported authentication tag.

9. A method for computing a variable-input-length pseudorandom function that uses a keyed block cipher to produce an authentication tag from a message, comprising:
determining a key variant by applying the keyed block cipher to a constant;
computing a sequence of offsets from the key variant; using the keyed block cipher to compute a checksum from the message and the sequence of offsets; and
applying the keyed block cipher to the checksum to yield the authentication tag.

10. A method for generating a sequence of offsets, to be used for authenticating messages between parties who share a secret key, comprising:
determining a key variant as a function of the secret key;
using the key variant to determine a sequence of basis offsets; and
determining a sequence of offsets from the sequence of basis offsets, wherein each offset in the sequence of basis offsets is determined by combining certain basis offsets from the sequence of basis offsets.

11. The method for generating a sequence of offsets as described in claim 10, wherein the basis offsets are combined in an order determined by a Gray code.

12. A method for computing a variable-input-length pseudorandom function that uses a block cipher, keyed by a given key, to produce an authentication tag from a message, the method comprising:
determining a stride value by applying the block cipher to a constant;
computing a first offsets using the block cipher;
computing each subsequent offset in a sequence of offsets by combining the prior offset and the stride value; and
computing the authentication tag using the block cipher, the message, and the sequence of offsets.

13. A computer-readable storage medium storing instructions that when executed by a computer cause the computer to perform a method for computing a variable-input-length pseudorandom function using an n-bit pseudorandom function, which transforms a key and a message to an authentication tag, the method comprising:
generating a sequence of offsets from the key;
partitioning the message into a sequence of n-bit message blocks and a message fragment having at most n bits;
combining each message block with a corresponding offset to get a corresponding input block;
applying the n-bit pseudorandom function to each input block to get a corresponding output block;
computing a checksum as a function of at least the output blocks and the final fragment; and
computing the authentication tag by applying the n-bit pseudorandom function to the checksum.

14. The computer-readable storage medium of claim 13, wherein generating the sequence of offsets involves:
determining the 1^{st} offset as a function of the key; and
determining the i^{th} offset, for each i>1, a function of the first offset and the number i.

15. The computer-readable storage medium of claim 13, wherein generating the sequence of offsets involves:
determining a plurality of basis offsets;
determining each offset in the sequence of offsets by combining a given set of basis offsets.

16. The computer-readable storage medium of claim 15, wherein the order that basis offsets are combined to make the i^{th} offset is determined by a Gray code.

17. The computer-readable storage medium of claim 13, wherein generating the sequence of offsets involves:
determining a stride and a first offset from the key; and
determining each subsequent offset by combining the prior offset and the stride.

18. A computer-readable storage medium storing instructions that when executed by a computer cause the computer to perform a method for computing a variable-input-length pseudorandom function that transforms a key and a message to an authentication tag, the method comprising:
generating a sequence of offsets from the key;
partitioning the message into a message core and a message fragment;
computing a partial checksum as a function of the message core, the sequence of offsets, and the key;
computing a final checksum as a function of at least the partial checksum and the message fragment; and
computing the authentication tag as a function of the final checksum and the key.

19. A computer-readable storage medium storing instructions that when executed by a computer cause the computer to perform a method for authenticating messages, using a key, that associates to each message an authentication tag, the method comprising:
generating a sequence of offsets from the key; partitioning the message into a message core and a message fragment;
computing a partial checksum as a function of the message core, the sequence of offsets, and the key;
computing a final checksum as a function of at least the partial checksum and the message fragment;
computing the authentication tag as a function of the final checksum and the key.

20. A computer-readable storage medium storing instructions that when executed by a computer cause the computer to perform a method for verifying the authenticity of messages, using a key, wherein a message is presented along with a purported authentication tag, the method comprising:
generating a sequence of offsets from the key;
partitioning the message into a message core and a message fragment;
computing a partial checksum as a function of the message core, the sequence of offsets, and the key;
computing a final checksum as a function of at least the partial checksum and the message fragment;
computing an authentication tag as a function of the final checksum and the key;
regarding the message as authentic if the authentication tag equals the purported authentication tag; and
regarding the message as inauthentic if the authentication tag differs from the purported authentication tag.

21. A computer-readable storage medium storing instructions that when executed by a computer cause the computer to perform a method for computing a variable-input-length pseudorandom function that uses a keyed block cipher to produce an authentication tag from a message, the method comprising:
determining a key variant by applying the keyed block cipher to a constant;
computing a sequence of offsets from the key variant;
using the keyed block cipher to compute a checksum from the message and the sequence of offsets; and
applying the keyed block cipher to the checksum to yield the authentication tag.

22. A computer-readable storage medium storing instructions that when executed by a computer cause the computer to perform a method for generating a sequence of offsets, to be used for authenticating messages between parties who share a secret key, the method comprising:
determining a key variant as a function of the secret key;
using the key variant to determine a sequence of basis offsets; and
determining a sequence of offsets from the sequence of basis offsets, wherein each offset in the sequence of basis offsets is determined by combining certain basis offsets from the sequence of basis offsets.

23. The computer-readable storage medium for generating a sequence of offsets as described in claim 10, wherein the basis offsets are combined in an order determined by a Gray code.

24. A computer-readable storage medium storing instructions that when executed by a computer cause the computer to perform a method for computing a variable-input-length pseudorandom function that uses a block cipher, keyed by a given key, to produce an authentication tag from a message, the method comprising:
determining a stride value by applying the block cipher to a constant;
computing a first offsets using the block cipher;
computing each subsequent offset in a sequence of offsets by combining the prior offset and the stride value; and
computing the authentication tag using the block cipher, the message, and the sequence of offsets.

25. An apparatus that computes a variable-input-length pseudorandom function using an n-bit pseudorandom function, which transforms a key and a message to an authentication tag, the apparatus comprising:
a generating mechanism that is configured to generate a sequence of offsets from the key;
a partitioning mechanism that is configured to partition the message into a sequence of n-bit message blocks and a message fragment having at most n bits;
a combining mechanism that is configured to combine each message block with a corresponding offset to get a corresponding input block;
a pseudorandom function mechanism that is configured to apply the n-bit pseudorandom function to each input block to get a corresponding output block;
a checksum mechanism that is configured to compute a checksum as a function of at least the output blocks and the final fragment; and
an authentication tag mechanism that is configured to compute the authentication tag by applying the n-bit pseudorandom function to the checksum.

26. An apparatus that computes a variable-input-length pseudorandom function that transforms a key and a message to an authentication tag, the apparatus comprising: a generation mechanism that is configured to generate a sequence of offsets from the key;
a partitioning mechanism that is configured to partition the message into a message core and a message fragment;
a checksum mechanism that is configured to,
compute a partial checksum as a function of the message core, the sequence of offsets, and the key, and to
compute a final checksum as a function of at least the partial checksum and the message fragment; and
an authentication tag mechanism that is configured to compute the authentication tag as a function of the final checksum and the key.

27. An apparatus that authenticates messages, using a key, that associates to each message an authentication tag, comprising:
a generation mechanism that is configured to generate a sequence of offsets from the key;
a partitioning mechanism that is configured to partition the message into a message core and a message fragment;
a checksum mechanism that is configured to,
compute a partial checksum as a function of the message core, the sequence of offsets, and the key, and to
compute a final checksum as a function of at least the partial checksum and the message fragment;
an authentication tag mechanism that is configured to compute the authentication tag as a function of the final checksum and the key.

28. An apparatus that computes a variable-input-length pseudorandom function that uses a keyed block cipher to produce an authentication tag from a message, comprising:
a key variant mechanism that is configured to determine a key variant by applying the keyed block cipher to a constant;
an offset mechanism that is configured to compute a sequence of offsets from the key variant;
a checksum mechanism that is configured to,
use the keyed block cipher to compute a checksum from the message and the sequence of offsets, and to
apply the keyed block cipher to the checksum to yield the authentication tag.

29. An apparatus that generates a sequence of offsets, to be used for authenticating messages between parties who share a secret key, comprising:
a key variant mechanism that is configured to determine a key variant as a function of the secret key;
a basis computing mechanism that is configured to,
use the key variant to determine a sequence of basis offsets, and to
determine a sequence of offsets from the sequence of basis offsets,
wherein each offset in the sequence of basis offsets is determined by combining certain basis offsets from the sequence of basis offsets.
